(19) United States
(12) Patent Application Publication
(10) Pub. No.: US 2014/0175928 A1
(43) Pub. Date: Jun. 26, 2014

(54) SPINDLE MOTOR

(71) Applicant: SAMSUNG ELECTRO-MECHANICS CO., LTD., Suwon (KR)

(72) Inventors: Hong Joo LEE, Suwon (KR); Hyung Ki MOON, Suwon (KR); Ju Ho KIM, Suwon (KR); Hak Kwan KIM, Suwon (KR); Hyun Ho SHIN, Suwon (KR)

(73) Assignee: Samsung Electro-Mechanics Co., Ltd., Suwon (KR)

(21) Appl. No.: 13/785,704

(22) Filed: Mar. 5, 2013

(30) Foreign Application Priority Data
Dec. 24, 2012 (KR) 10-2012-0152056

(51) Int. Cl. H02K 1/27

(52) U.S. Cl. CPC H02K 1/2786
USPC 310/156.04

(57) ABSTRACT

There is provided a spindle motor including a stator including a base member in which a stator core is fixedly installed, and a rotor including a rotor hub in which a driving magnet disposed to face the stator core is installed, wherein the driving magnet is installed on a magnet mounting part provided in the rotor hub so that the magnetic center thereof in an axial direction is disposed in a position higher than that of the magnetic center of the stator core in the axial direction in order to generate force directed in a downward axial direction by interaction with the stator core, and the stator core is formed of a soft magnetic material and includes protrusion parts formed at a front end portion thereof disposed to face the driving magnet and extended therefrom in the axial direction.

### CROSS-REFERENCE TO RELATED APPLICATIONS

This application claims the priority of Korean Patent Application No. 10-2012-0152056 filed on Dec. 24, 2012, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A hard disk drive (HDD), an information storage device, reads data stored on a disk or writes data to a disk using a read/write head.

A hard disk drive requires a disk driving device capable of driving the disk. In the disk driving device, a small-sized spindle motor is used.

Meanwhile, the spindle motor according to the related art requires floating force for rotating a rotor. In this case, in order to prevent the rotor from being separated from a stator in the case that an amount of floating force required for rotating the rotor is excessively generated in the spindle motor and an external impact is applied to the spindle motor, a pulling plate has been disposed below a driving magnet to suppress the floating force.

Alternatively, a configuration in which the pulling plate is omitted and the driving magnet is installed in a rotor hub so that the magnetic center of the driving magnet is disposed in a position higher than that of the magnetic center of a stator core in an axial direction to generate force in a downward axial direction, thereby preventing the rotor from being separated from the stator when the amount of floating force required for rotating the rotor is excessively generated in the spindle motor and the external impact is applied to the spindle motor has been adopted.

However, in the case in which the driving magnet is installed in the rotor hub so that the magnetic center of the driving magnet is disposed in the position higher than that of the magnetic center of the stator core in the axial direction, a predetermined space is formed under the driving magnet.

As described above, in the case in which the magnetic center of the driving magnet is disposed in the position higher than that of the magnetic center of the stator core in the axial direction, an axial length of the driving magnet is decreased, such that driving torque generated by interaction between the driving magnet and the stator core is deteriorated.

Further, the predetermined space is formed under the driving magnet, such that a vortex may be generated by flowing air. Further, noise and/or vibrations are generated due to the generation of the vortex at the time of rotation of the rotor hub.

### RELATED ART DOCUMENT

Japanese Patent Laid-Open Publication No. 2007-306686

### SUMMARY OF THE INVENTION

An aspect of the present invention provides a spindle motor capable of increasing driving torque generated by an electromagnetic interaction between a driving magnet and a stator core.

An aspect of the present invention also provides a spindle motor capable of decreasing noise and vibrations generated at the time of rotation of a rotor.

According to an aspect of the present invention, there is provided a spindle motor including: a stator including a base member in which a stator core is fixedly installed; and a rotor including a rotor hub in which a driving magnet disposed to face the stator core is installed, wherein the driving magnet is installed on a magnet mounting part provided in the rotor hub so that the magnetic center thereof in an axial direction is disposed in a position higher than that of the magnetic center of the stator core in the axial direction in order to generate force directed in a downward axial direction by interaction with the stator core, and the stator core is formed of a soft magnetic material and includes protrusion parts formed at a front end portion thereof disposed to face the driving magnet and extended therefrom in the axial direction.

The stator core may include a coreback having an annular ring shape, a plurality of teeth respectively extended from the coreback in an outer diameter direction, extension parts respectively extended from distal ends of the teeth in a circumferential direction, and the protrusion parts respectively extended from lower end portions of the extension parts.

The rotor hub may include a body having a disk shape, a magnet mounting part extended from an edge of the body downwardly in the axial direction, and a disk supporting part extended from the magnet mounting part in an outer diameter direction, and the driving magnet may have an axial length at which an upper surface thereof contacts a lower surface of the body and a lower surface thereof is disposed in parallel with a lower surface of the magnet mounting part.

A lower surface of the driving magnet and a lower surface of the protrusion part of the stator core may be disposed on the same plane.

A lower surface of the disk supporting part may be formed as an inclined surface inclined upwardly in an outer diameter direction, a facing surface of the base member disposed to face the inclined surface of the disk supporting part may be disposed in parallel with the inclined surface, and a clearance formed by the driving magnet and the base member and a clearance formed by the inclined surface and the facing surface may have the same width.

The stator may include: the base member including an installation part at which the stator core is installed; a lower thrust member fixedly installed on an inner surface of the installation part; a shaft having a lower end portion fixedly installed on the lower thrust member; and an upper thrust member fixedly installed on an upper end portion of the shaft.

The rotor may include a sleeve forming, together with the lower thrust member, the shaft, and the upper thrust member, bearing clearances, and the rotor hub extended from the sleeve.

According to another aspect of the present invention, there is provided a spindle motor including: a base member having a stator core fixedly installed therein; a sleeve fixedly installed on the base member; a shaft inserted into the sleeve and rotating; and a rotor hub fixedly installed the shaft and including a body having a disk shape, a magnet mounting part extended from an edge of the body in a downward axial direction and having a driving magnet installed on an inner surface thereof, and a disk supporting part extended from the magnet mounting part in an outer diameter direction, wherein the driving magnet is installed on the magnet mounting part so that the magnetic center thereof in an axial direction is disposed in a position higher than that of the magnetic center of the stator core in the axial direction in order to generate force directed in a downward axial direction by interaction with the stator core, and the stator core is formed of a soft magnetic material and includes protrusion parts formed at a front end portion thereof disposed to face the driving magnet and extended therefrom in the axial direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a perspective view showing a stator core included in the spindle motor according to the embodiment of the present invention; and

FIG. 4 is a schematic cross-sectional view showing a spindle motor according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

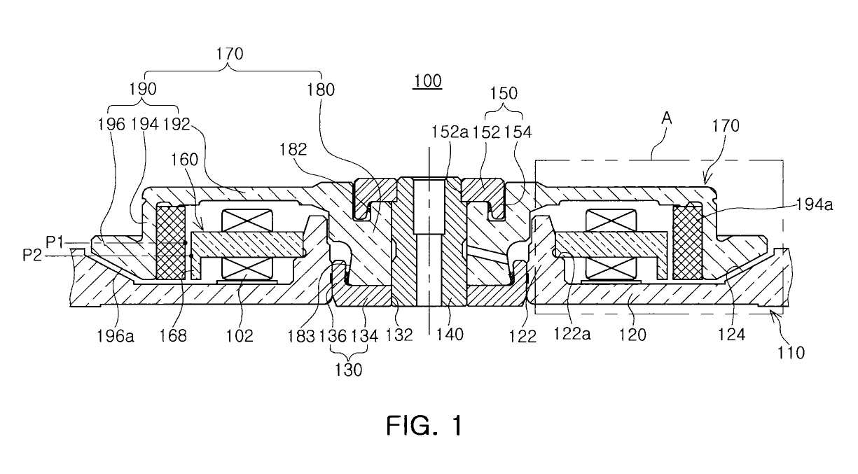

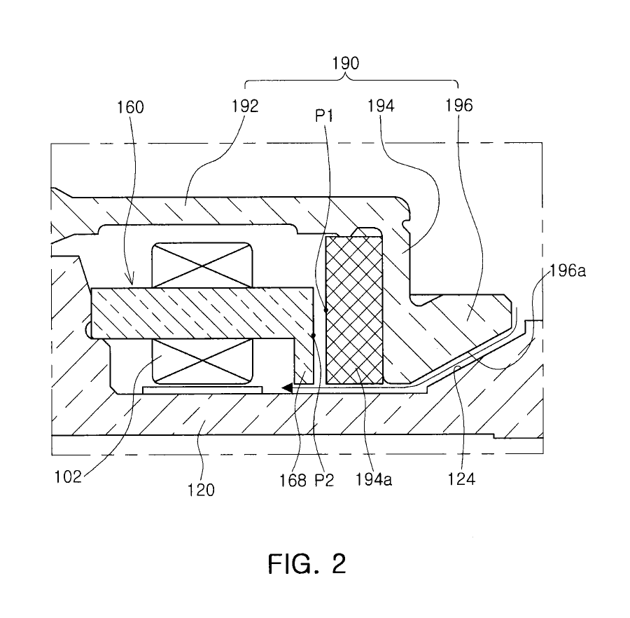

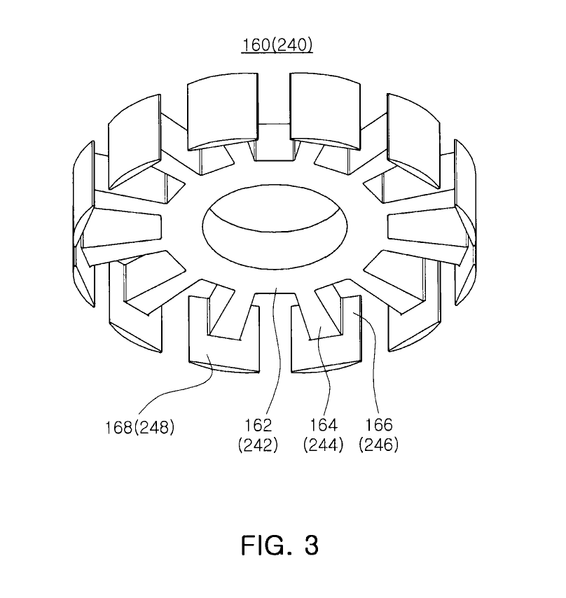

FIG. 1 is a schematic cross-sectional view showing a spindle motor according to an embodiment of the present invention; FIG. 2 is an enlarged view of part A of FIG. 1; and FIG. 3 is a perspective view showing a stator core included in the spindle motor according to the embodiment of the present invention.

Referring to FIGS. 1 through 3, the spindle motor 100 according to the embodiment of the present invention may include a stator 110 and a rotor 170 by way of example.

Meanwhile, the stator 110, all fixed members with the exception of a rotating member, may include a base member 120, a lower thrust member 130, a shaft 140, an upper thrust member 150, a stator core 160, and the like.

In addition, the rotor 170 refers to a member rotating around the shaft 140, a rotating axis.

In addition, the spindle motor 100 according to the embodiment of the present invention may be a motor used in an information recording and reproducing device such as a hard disk driving device, or the like, by way of an example.

Here, terms with respect to directions will be defined. As viewed in FIG. 1, an axial direction refers to a vertical direction, that is, a direction from a lower portion of the shaft 140 toward an upper portion thereof or a direction from the upper portion of the shaft 140 toward the lower portion thereof, and a radial direction refers to a horizontal direction, that is, a direction from the shaft 140 toward an outer peripheral surface of the rotor 170 or from the outer peripheral surface of the rotor 170 toward the shaft 140.

In addition, a circumferential direction refers to a rotation direction along an outer peripheral surface of the shaft 140 or the outer peripheral surface of the rotor 170.

The base member 120, a fixed member configuring the stator 110 as described above, may include an installation part 122 into which the lower thrust member 130 is inserted. The installation part 122 may be extended from the base member 120 in an upward axial direction and have a step surface 122a formed in an outer peripheral surface thereof so that the stator core 160 may be fixedly installed thereto.

Meanwhile, the base member 120 may have an inclined facing surface 124 disposed to face the rotor 170. A detailed description thereof will be provided below.

The lower thrust member 130, a fixed member configuring, together with the base member 120, the stator 110, may be fixedly installed on the base member 120.

In addition, the lower thrust member 130 may have a hollow cup shape. That is, the lower thrust member 130 may have an installation hole 132 formed therein so that a lower end portion of the shaft 140 may be inserted thereinto and fixed thereto.

In addition, the lower thrust member 130 may include a disk part 134 and an extension part 136 extended from an edge of the disk part 134 in the upward axial direction.

The shaft 140, also a fixed member configuring the stator 110, may have the lower end portion fixedly installed on the lower thrust member 130 as described above. That is, the lower end portion of the shaft 140 may be inserted into the installation hole 132 formed in the disk part 134.

In addition, the shaft 140 may serve as the rotation axis of the rotor 170, and the rotor 170 may rotate around the shaft 140 as an axis.

The upper thrust member 150, which also is a fixed member configuring the stator 110, may be fixedly installed on an upper end portion of the shaft 140.

In addition, the upper thrust member 150 may also have a shape similar to that of the lower thrust member 130. That is, the upper thrust member 150 may include a circular ring part 152 and an extension wall part 154 extended from the ring part 152 in a downward axial direction.

In addition, the circular ring part 152 may also have a through-hole 152a formed therein so that the upper end portion of the shaft 140 is inserted thereinto.

The stator core 160 may be fixedly installed on the installation part 122 of the base member 120 as described above. In addition, the stator core 160 may include a coreback 162 having an annular ring shape, a plurality of teeth 164 respectively extended from the coreback 162 in an outer diameter direction, extension parts 166 respectively extended from distal ends of the teeth 164 in the circumferential direction, and protrusion parts 168 respectively extended from lower end portions of the extension parts 166, as shown in detail in FIG. 3.

In addition, the extension part 166 and the protrusion part 168 may be disposed to face a driving magnet 194a provided in the rotor 170, to be described below.

A detailed description thereof will be provided below.

The stator core 160 may be formed of a soft magnetic material, and the coreback 162, the teeth 164, the extension parts 166, and the protrusion parts 168 may be formed integrally with one another.

That is, the stator core 160 may be manufactured at a time by filling the soft magnetic material in a mold. Therefore, a shape of the protrusion part 168 may be freely changed and manufactured.

The rotor 170 may include a rotor hub 190 in which a driving magnet 194a disposed to face the stator core 160 is installed. In addition, the rotor 170 may include a sleeve 180 forming, together with the lower thrust member 130, the shaft 140, and the upper thrust member 150, bearing clearances, and the rotor hub 190 extended from the sleeve 180.

Meanwhile, although the case in which the sleeve 180 and the rotor hub 190 are formed integrally with each other is described in the present embodiment, the present invention is not limited thereto. That is, the sleeve 180 and the rotor hub 190 may be manufactured as separate members and then coupled to each other.

The sleeve 180 may form, together with the lower thrust member 130, the shaft 140, and the upper thrust member 150, the bearing clearances as described above, wherein the bearing clearances may be filled with a lubricating fluid.

In addition, the spindle motor 100 according to the embodiment of the present invention may have a full-fill structure in which the lubricating fluid is filled in all of the above-mentioned bearing clearances.

Meanwhile, the sleeve 180 may have upper and lower inclined parts 182 and 183 formed on an outer peripheral surface thereof so as to form an interface between the lubricating fluid and air together with the upper and lower thrust members 150 and 130.

That is, the sleeve 180 may have the upper inclined part 182 formed at an upper end portion of the outer peripheral surface thereof so as to form a liquid-vapor interface together with the upper thrust member 150. Further, the lubricating fluid filled in the bearing clearance may form the interface with the air in a space formed by the extension wall part 154 of the upper thrust member 150 and the upper inclined part 182 by a capillary phenomenon.

In addition, the sleeve 180 may have the lower inclined part 183 formed at a lower end portion of the outer peripheral surface thereof so as to forma liquid-vapor interface together with the lower thrust member 130. Further, the lubricating fluid filled in the bearing clearance may form the interface with the air in a space formed by the extension part 136 of the lower thrust member 130 and the lower inclined part 183 by a capillary phenomenon.

Further, the sleeve 180 may include a radial dynamic pressure groove (not shown) formed in an inner surface thereof in order to generate fluid dynamic pressure at the time of rotation. The radial dynamic pressure groove may have a herringbone shape or a spiral shape pattern and include upper and lower radial dynamic pressure grooves.

Further, a thrust dynamic pressure groove (not shown) may be formed in at least one of a lower surface of the sleeve 180 and a facing surface of the lower thrust member 130 disposed to face the lower surface of the sleeve 180 and/or at least one of an upper surface of the sleeve 180 and a facing surface of the upper thrust member 150 disposed to face the upper surface of the sleeve 180. The thrust dynamic pressure groove may also have a herringbone shape or a spiral shape.

The rotor hub 190 may be extended from the sleeve 180. In addition, the rotor hub 190 may include a body 192 having a disk shape, a magnet mounting part 194 extended from an edge of the body 192 downwardly in the axial direction, and a disk supporting part 196 extended from the magnet mounting part 194 in the outer diameter direction.

Meanwhile, the magnet mounting part 194 may include the driving magnet 194a installed on an inner surface thereof. The driving magnet 194a may be installed on the magnet mounting part 194 so as to be disposed to face a front end of the stator core 160.

Here, rotational driving of the rotor 170 will be schematically described. When power is supplied to a coil 102 wound around the stator core 160, the driving magnet 194a and the stator core 160 having the coil 102 wound therearound may electromagnetically interact with each other to generate driving force capable of rotating the rotor 170.

To this end, the driving magnet 194a may be a permanent magnet in which N and S poles are alternately magnetized in the circumferential direction.

Meanwhile, the driving magnet 194a may be installed so that the magnetic center P1 thereof in the axial direction is disposed in a position higher than that of the magnetic center P2 of the stator core 160 in the axial direction in order to generate force directed downwardly in the axial direction by interaction with the stator core 160.

Therefore, a pulling plate for suppressing excessive floating of the rotor 170 may not be installed on the base member 120.

In addition, the driving magnet 194a may have an axial length at which an upper surface thereof contacts a lower surface of the body 192 and a lower surface thereof is disposed in parallel with a lower surface of the magnet mounting part 194.

Therefore, a facing area between the driving magnet 194a and the stator core 160 is increased, such that driving torque generated by an electromagnetic interaction between the driving magnet 194a and the stator core 160 may be increased.

That is, the magnetic center of the driving magnet 194a and the magnetic center of the stator core 160 are disposed to be different from each other to increase the axial length of the driving magnet 194a through the protrusion part 168 of the stator core 160 while generating force directed toward the center in the axial direction, whereby driving torque may be increased.

In addition, the lower surface of the driving magnet 194a and a lower surface of the protrusion part 168 of the stator core 160 may be disposed on the same plane by way of example. However, the present invention is not limited thereto. That is, the lower surface of the driving magnet 194a and the lower surface of the protrusion part 168 of the stator core 160 may also be disposed on planes adjacent to each other in the axial direction, respectively.

Meanwhile, a lower surface of the disk supporting part 196 may be formed as an inclined surface 196a inclined upwardly in the outer diameter direction, and the facing surface 124 of the base member 120 disposed to face the inclined surface 196a of the disk supporting part 196 may be disposed in parallel with the inclined surface 196a.

In addition, a clearance formed by the driving magnet 194a and the base member 120 and a clearance formed by the inclined surface 196a and the facing surface 124 may have the same width (that is, a gap having the same distance).

That is, the axial length of the driving magnet 194a is increased, such that the clearance formed by the driving magnet 194a and the base member 120 and the clearance formed by the inclined surface 196a and the facing surface 124 may have the same width (that is, the gap having the same distance).

Therefore, generation of a vortex due to air flowing through the inclined surface 196a and the facing surface 124 at the time of the rotation of the rotor hub 190 may be decreased.

A detailed description thereof will be provided below. In the case in which the length of the driving magnet 194a is not increased, the clearance formed by the inclined surface 196a and the facing surface 124 and the clearance formed by a lower end portion of the driving magnet 194a and the upper surface of the base member 120 may have a step therebetween. That is, the clearance may be rapidly widened at a connection portion between the clearance formed by the lower end portion of the driving magnet 194a and the upper surface of the base member 120 and the clearance formed by the inclined surface 196a and the facing surface 124.

In this case, a speed of the flowing air and pressure formed by the flowing air may be rapidly changed. Therefore, a vortex is generated by the flowing air, such that the vibration and/or the noise may be generated at the time of the rotation of the rotor hub 190.

However, since the driving magnet 194a has the axial length at which it arrives at the lower end portion of the magnet mounting part 194, the clearance formed by the inclined surface 196a and the facing surface 124 and the clearance formed by the lower surface of the driving magnet 194a and the upper surface of the base member 120 may not have a step therebetween. Therefore, the generation of the vortex may be decreased. Further, the vibration and/or the noise generated at the time of the rotation of the rotor hub 190 may be decreased.

As described above, since the axial length of the driving magnet 194a may be increased through the protrusion part 168 of the stator core 160, the driving torque generated by electromagnetic interaction between the stator core 160 and the driving magnet 194a may be increased.

Further, the axial length of the driving magnet 194a is increased to decrease generation of the vortex, whereby the generation of the vibrations and/or noise may be decreased.

Hereinafter, a spindle motor according to another embodiment of the present invention will be described with reference to the accompanying drawings.

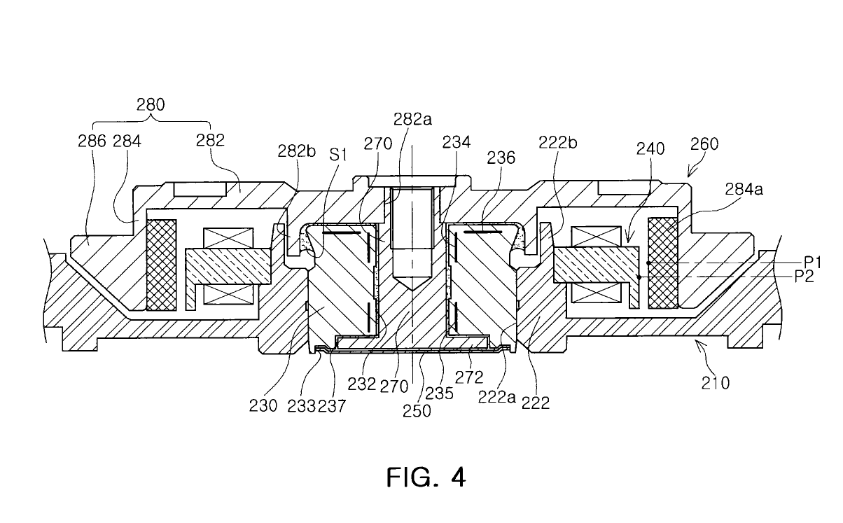

FIG. 4 is a schematic cross-sectional view showing a spindle motor according to another embodiment of the present invention.

Referring to FIGS. 2 and 4, the spindle motor 200 according to the embodiment of the present invention may include a stator 210 and a rotor 260 by way of example.

Meanwhile the stator 210, all fixed members except for a rotating member, may include abase member 220, a sleeve 230, a stator core 240, and the like.

In addition, the rotor 260, a member rotating together with a shaft 270, may include the shaft 270 and a rotor hub 280.

The base member 220 may include an installation part 222 into which the sleeve 230 is inserted. The installation part 222 may protrude in the upward axial direction and include a hole 222a formed therein so that the sleeve 230 may be inserted thereinto.

Meanwhile, the installation part 222 may include a protrusion wall body 222b for forming a labyrinth seal together with the rotor hub 280. In addition, the protrusion wall body 222b may include a stator core 240 installed on an outer peripheral surface thereof, wherein the stator core 240 has a coil 202 wound therearound. The stator core 240 may be fixedly installed on the outer peripheral surface of the protrusion wall body 222b by an adhesion or press-fitting method.

In addition, the base member 220 may be manufactured by performing die-casting using an aluminum (Al) material. Alternatively, the base member 220 may also be molded by performing plastic working (for example, press working) on a steel plate.

That is, the base member 220 may be manufactured by various materials and various processing methods, and is not limited to the base member 220 shown in FIGS. 5 and 6.

The sleeve 230, a fixed member configuring, together with the base member 220, the stator 210, may be fixedly installed on the base member 220.

That is, the sleeve 230 may be inserted into and fixed to the above-mentioned installation part 222. In other words, a lower end portion of an outer peripheral surface of the sleeve 230 may be bonded to an inner peripheral surface of the installation part 222 by at least one of an adhesion method, a welding method, and a press-fitting method.

Further, the sleeve 230 may include a shaft hole 232 formed therein, wherein the shaft hole 232 has the shaft 270 inserted thereinto. The shaft 270 may be inserted into the shaft hole 232 and be rotatably supported by the sleeve 230.

In addition, the sleeve 230 may include a mounting groove 233 formed in a lower end portion thereof, wherein the mounting groove 233 has a cover member 250 installed therein in order to prevent leakage of the lubricating fluid. Further, at the time of installing the cover member 250, a bearing clearance filled with the lubricating fluid may be formed by an upper surface of the cover member 250 and a lower surface of the shaft 270.

Hereinafter, the bearing clearance will be described.

The bearing clearance indicates a clearance filled with the lubricating fluid. That is, all of a clearance formed by an inner surface of the sleeve 230 and an outer surface of the shaft 270, a clearance formed by the sleeve 230 and the rotor hub 280, and a clearance formed by the cover member 250 and the shaft 270 are defined as the bearing clearance.

In addition, the spindle motor 200 according to the present embodiment may have a structure in which the lubricating fluid is filled in all of the above-mentioned bearing clearances. This structure may also be called a full-fill structure.

In addition, the sleeve 230 may include upper and lower radial dynamic pressure grooves 234 and 235 formed in an inner peripheral surface thereof in order to generate fluid dynamic pressure at the time of rotational driving of the shaft 270. In addition, the upper and lower radial dynamic pressure grooves 234 and 235 may be disposed to be spaced apart from each other by a predetermined interval and have a herringbone or spiral shape pattern.

However, the above-mentioned upper and low radial dynamic pressure grooves 234 and 235 are not limited to being formed in the inner peripheral surface of the sleeve 230, but may also be formed in the outer peripheral surface of the shaft 270.

Further, an upper end portion of the outer peripheral surface of the sleeve 230 may be inclined so as to form a liquid-vapor interface S1 together with the rotor hub 280.

That is, the upper end portion of the outer peripheral surface of the sleeve 230 may be inclined in order to form the liquid-vapor interface S1 between the lubricating fluid and the air by the capillary phenomenon.

Meanwhile, a thrust dynamic pressure groove 236 may be formed in an upper surface of the sleeve 230. In addition, the thrust dynamic pressure groove 236 may also be formed in a lower surface of the rotor hub 280 disposed to face the upper surface of the sleeve 230. That is, the thrust dynamic pressure groove 236 may be formed in at least one of the upper surface of the sleeve 230 and the lower surface of the rotor hub 280 disposed to face the upper surface of the sleeve 230.

However, the thrust dynamic pressure groove 236 is not limited to being formed in at least one of the upper surface of the sleeve 230 and the lower surface of the rotor hub 280 disposed to face the upper surface of the sleeve 230, but may also be formed in at least one of the lower surface of the shaft 270 and the upper surface of the cover member 250.

The thrust dynamic pressure groove 236 may generate dynamic pressure floating the rotor hub 280 at a predetermined height at the time of rotation of the rotor hub 280, and the liquid-vapor interface S1 may move toward the bearing clearance by the floating of the rotor hub 280.

The stator core 240 may be fixedly installed on the installation part 222 of the base member 220 as described above. In addition, the stator core 240 may include a coreback 242 having an annular ring shape, a plurality of teeth 244 respectively extended from the coreback 242 in the outer diameter direction, extension parts 246 respectively extended from distal ends of the teeth 244 in the circumferential direction, and protrusion parts 248 respectively extended from lower end portions of the extension parts 246, as shown in detail in FIG. 3.

In addition, the extension part 246 and the protrusion part 248 may be disposed to face a driving magnet 284a (to be described below) installed in the rotor hub 280.

A detailed description thereof will be provided below.

Meanwhile, the stator core 240 may be formed of a soft magnetic material, and the coreback 242, the teeth 244, the extension parts 246, and the protrusion parts 248 may be formed integrally with one another.

That is, the stator core 240 may be manufactured at a time by filling the soft magnetic material in a mold. Therefore, a shape of the protrusion part 248 may be freely changed and manufactured.

The shaft 270, a rotating member, may configure the rotor 260 and be inserted into the sleeve 230 and rotate. That is, the shaft 270 may be rotatably supported by the sleeve 230. In addition, the shaft 270 may include a flange part 272 formed at a lower end portion thereof, wherein the flange part 272 is inserted into a step groove 237.

The flange part 272 may be extended from the lower end portion of the shaft 270 in the outer diameter direction and serve to prevent excessive floating of the shaft 270 simultaneously with preventing the shaft 270 from being separated upwardly from the sleeve 230.

That is, the flange part 272 may prevent the shaft 270 from being separated upwardly from the sleeve 230 due to external impact. In addition, the shaft 270 may be floated at a predetermined height at the time of the rotational driving thereof. At this time, the flange part 272 may serve to prevent the shaft 270 from being excessively floated.

Further, the shaft 270 may have the rotor hub 280 coupled to an upper end portion thereof. To this end, in the case in which the shaft 270 is installed in the sleeve 230, the upper end portion of the shaft 270 may be disposed to protrude upwardly of the sleeve 230.

The rotor hub 280, a rotating member configuring the rotor 260 together with the shaft 270, may be fixedly installed on the upper end portion of the shaft 270 and rotate together with the shaft 270.

Meanwhile, the rotor hub 280 may include a body 282 provided with an mounting hole 282a into which the upper end portion of the shaft 270 is inserted, a magnet mounting part 284 extended from an edge of the body 282 downwardly in the axial direction, and a disk supporting part 286 extended from an distal end of the magnet mounting part 284 in the outer diameter direction.

In addition, the magnet mounting part 284 may have a driving magnet 284a installed on an inner surface thereof, wherein the driving magnet 284a is disposed to face a front end of the stator core 240 having a coil 202 wound therearound.

Meanwhile, the driving magnet 284a may have an annular ring shape and be a permanent magnet generating magnetic force having a predetermined strength by alternately magnetizing N and S poles in the circumferential direction.

Meanwhile, the body 282 may be provided with an extension wall body 282b extended downwardly in the axial direction so as to form an interface between the lubricating fluid and air, that is, a liquid-vapor interface 51, together with the outer peripheral surface of the sleeve 230.

An inner surface of the extension wall body 282b may be disposed to face the upper end portion of the outer peripheral surface of the sleeve 430.

Meanwhile, the driving magnet 284a may be installed on the magnet mounting part 254 so that the magnetic center P1 thereof in the axial direction is disposed in a position higher than that of the magnetic center P2 of the stator core 240 in the axial direction in order to generate force directed downwardly in the axial direction by interaction with the stator core 240.

Therefore, a pulling plate for suppressing excessive floating of the rotor hub 280 may not be installed on the base member 220.

In addition, the driving magnet 284a may have an axial length at which an upper surface thereof contacts a lower surface of the body 282 and a lower surface thereof is disposed in parallel with a lower surface of the magnet mounting part 284.

Therefore, a facing area between the driving magnet 284a and the stator core 240 is increased, such that driving torque generated by electromagnetic interaction between the driving magnet 284a and the stator core 240 may be increased.

That is, the magnetic center of the driving magnet 284a and the magnetic center of the stator core 240 are disposed to be different from each other to increase the axial length of the driving magnet 284a through the protrusion part 248 of the stator core 240 while generating force directed toward the center in the axial direction, whereby driving torque may be increased.

In addition, the lower surface of the driving magnet 284a and a lower surface of the protrusion part 248 of the stator core 240 may be disposed on the same plane by way of example. However, the present invention is not limited thereto. That is, the lower surface of the driving magnet 284a and the lower surface of the protrusion part 248 of the stator core 240 may also be disposed on planes adjacent to each other in the axial direction, respectively.

Meanwhile, a lower surface of the disk supporting part 286 may be formed as an inclined surface 286a inclined upwardly in the outer diameter direction, and the facing surface 224 of the base member 220 disposed to face the inclined surface 286a of the disk supporting part 286 may be disposed in parallel with the inclined surface 286a.

In addition, a clearance formed by the driving magnet 284a and the base member 220 and a clearance formed by the inclined surface 286a and the facing surface 224 may have the same width (that is, a gap having the same distance).

That is, the axial length of the driving magnet 284a is increased, such that the clearance formed by the driving magnet 284a and the base member 220 and the clearance formed by the inclined surface 286a and the facing surface 224 may have the same width (that is, the gap having the same distance).

Therefore, generation of a vortex due to air flowing through the inclined surface 286a and the facing surface 224 at the time of the rotation of the rotor hub 280 may be decreased.

A detailed description thereof will be described below. In the case in which the length of the driving magnet 284a is not increased, the clearance formed by the inclined surface 286a and the facing surface 224 and the clearance formed by a lower end portion of the driving magnet 284a and the upper surface of the base member 220 may have a step therebetween. That is, the clearance may be rapidly widened at a connection portion between the clearance formed by the lower end portion of the driving magnet 284a and the upper surface of the base member 220 and the clearance formed by the inclined surface 286a and the facing surface 224.

In this case, a speed of the flowing air and pressure formed by the flowing air may be rapidly changed. Therefore, a vortex may be generated by the flowing air, such that the vibrations and/or the noise may be generated at the time of the rotation of the rotor hub 280.

However, since the driving magnet 284a has the axial length at which it arrives at the lower end portion of the magnet mounting part 284, the clearance formed by the inclined surface 286a and the facing surface 224 and the clearance formed by the lower surface of the driving magnet 284a and the upper surface of the base member 220 may not have a step therebetween. Therefore, the generation of the vortex may be decreased. Further, the vibration and/or the noise generated at the time of the rotation of the rotor hub 280 may be decreased.

As described above, since the axial length of the driving magnet 284a may be increased through the protrusion part 248 of the stator core 240, the driving torque generated by the electromagnetic interaction between the stator core 240 and the driving magnet 284a may be increased.

Further, the axial length of the driving magnet 284a is increased to decrease generation of the vortex, whereby the generation of the vibration and/or the noise may be decreased.

As set forth above, according to the embodiments of the present invention, since the axial length of the driving magnet may be increased through the protrusion part of the stator core, a facing area between the stator core and the driving magnet may be increased.

Therefore, the driving torque generated by the electromagnetic interaction between the stator core and the driving magnet may be increased.

Further, the axial length of the driving magnet is increased, whereby the noise and the vibration generated at the time of the rotation of the rotor may be decreased.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a stator including a base member in which a stator core is fixedly installed; and
a rotor including a rotor hub in which a driving magnet disposed to face the stator core is installed,
wherein the driving magnet is installed on a magnet mounting part provided in the rotor hub so that the magnetic center thereof in an axial direction is disposed in a position higher than that of the magnetic center of the stator core in the axial direction in order to generate force directed in a downward axial direction by interaction with the stator core, and
the stator core is formed of a soft magnetic material and includes protrusion parts formed at a front end portion thereof disposed to face the driving magnet and extended therefrom in the axial direction.

2. The spindle motor of claim 1, wherein the stator core includes a coreback having an annular ring shape, a plurality of teeth respectively extended from the coreback in an outer diameter direction, extension parts respectively extended from distal ends of the teeth in a circumferential direction, and the protrusion parts respectively extended from lower end portions of the extension parts.

3. The spindle motor of claim 1, wherein the rotor hub includes a body having a disk shape, a magnet mounting part extended from an edge of the body downwardly in the axial direction, and a disk supporting part extended from the magnet mounting part in an outer diameter direction, and
the driving magnet has an axial length at which an upper surface thereof contacts a lower surface of the body and a lower surface thereof is disposed in parallel with a lower surface of the magnet mounting part.

4. The spindle motor of claim 1, wherein a lower surface of the driving magnet and a lower surface of the protrusion part of the stator core are disposed on the same plane.

5. The spindle motor of claim 3, wherein a lower surface of the disk supporting part is formed as an inclined surface inclined upwardly in an outer diameter direction,
a facing surface of the base member disposed to face the inclined surface of the disk supporting part is disposed in parallel with the inclined surface, and
a clearance formed by the driving magnet and the base member and a clearance formed by the inclined surface and the facing surface have the same width.

6. The spindle motor of claim 1, wherein the stator includes:
the base member including an installation part at which the stator core is installed;
a lower thrust member fixedly installed on an inner surface of the installation part;
a shaft having a lower end portion fixedly installed on the lower thrust member; and
an upper thrust member fixedly installed on an upper end portion of the shaft.

7. The spindle motor of claim 6, wherein the rotor includes a sleeve forming, together with the lower thrust member, the shaft, and the upper thrust member, bearing clearances, and the rotor hub extended from the sleeve.

8. A spindle motor comprising:
a base member having a stator core fixedly installed therein;
a sleeve fixedly installed on the base member;
a shaft inserted into the sleeve and rotating; and
a rotor hub fixedly installed on the shaft and including a body having a disk shape, a magnet mounting part extended from an edge of the body in a downward axial direction and having a driving magnet installed on an inner surface thereof, and a disk supporting part extended from the magnet mounting part in an outer diameter direction,
wherein the driving magnet is installed on the magnet mounting part so that the magnetic center thereof in an axial direction is disposed in a position higher than that of the magnetic center of the stator core in the axial direction in order to generate force directed in a downward axial direction by interaction with the stator core, and
the stator core is formed of a soft magnetic material and includes protrusion parts formed at a front end portion thereof disposed to face the driving magnet and extended therefrom in the axial direction.

9. The spindle motor of claim 8, wherein the stator core includes a coreback having an annular ring shape, a plurality of teeth respectively extended from the coreback in an outer diameter direction, extension parts respectively extended from distal ends of the teeth in a circumferential direction, and the protrusion parts respectively extended from lower end portions of the extension parts.

10. The spindle motor of claim 8, wherein the driving magnet has an axial length at which an upper surface thereof contacts a lower surface of the body and a lower surface thereof is disposed in parallel with a lower surface of the magnet mounting part.
